(19) United States
(12) Patent Application Publication
(10) Pub. No.: US 2005/0017941 A1
(43) Pub. Date: Jan. 27, 2005

(54) Driver circuit for an LCD display

(75) Inventors: Helmut Simon, Argenbuhl (DE); Roland Morent, Wangen (DE)

Correspondence Address: LERNER AND GREENBERG, PA, P O BOX 2480, HOLLYWOOD, FL, 33022-2480, US

(73) Assignee: Diehl AKO Stiftung & Co. KG

(21) Appl. No.: 10/926,417

(22) Filed: Aug. 25, 2004

Related U.S. Application Data
(63) Continuation of application No. PCT/EP03/01523, filed on Feb. 15, 2003.

(30) Foreign Application Priority Data
Feb. 25, 2002 (DE) 102 08 073.9

(51) Int. Cl. G09G 3/36

(52) U.S. Cl. 345/98

(57) ABSTRACT

In spite of the enormous market-originating price pressure, even large-scale domestic appliances can be fitted with LCD displays for user guidance. The expensive universal driver circuits (LCD controller ICs) with their many unused functionalities are replaced by simple logic gate circuits synchronized by a host processor for the exchange of image data between the V-RAM and the display, for cyclically successively counting through the pixels (that is to say columns) per image line and the lines per image representation of the display. As now an address in the V-RAM and thus a matrix position in the image of the display corresponds to each counting position per image, and the memory is not occupied with image data continuously but only in a corresponding section. This however is not a problem because large image data memories are available very inexpensively in comparison with an expensive LCD controller IC.

### CROSS-REFERENCE TO RELATED APPLICATION

This application is a continuation, under 35 U.S.C. § 120, of copending international application No. PCT/EP03/01523, filed Feb. 15, 2003, which designated the United States; this application also claims the priority, under 35 U.S.C. § 119, of German patent application No. 102 08 073.9, filed Feb. 25, 2002; the prior applications are herewith incorporated by reference in their entirety.

### BACKGROUND OF THE INVENTION

### FIELD OF THE INVENTION

The invention concerns a driver circuit for mosaic-like image representation on an LCD display by a V-RAM to be loaded with image data by way of a host processor.

A circuit of the general kind set forth is known from U.S. Pat. No. 6,320,575 and is a memory controller for the operation of a liquid crystal display. Provided for addressing the memory are two counters associated with different regions, which are alternately reset and enabled by horizontal and vertical synchronizing circuits for line-wise image construction.

European Patent Application EP 0 631 270 A2, corresponding to U.S. Pat. Nos. 5,852,428, 5,703,616, and 5,663,745, describes an LCD display driver whose display memory is fed from an address register with x and y-addresses for line-wise image construction.

Special driver circuits are commercially available for the actuation of large LCD displays with for example 76,800 pixels per image. Such circuits have processors which are optimized for those control tasks, as are described for example in the “Technical Manual S1D13305 Series” from Seiko Epson Corporation, page 2001, in the form of LCD controller ICs.

In the configuration of such a processor which serves as an LCD driver circuit, it is usually provided that it can receive commands and image data from a host processor and deliver signals for time matching, for which purpose it is provided with its own clock generator. Such processors are also optimized for corresponding with large memories. They are referred to in that use as video-RAM (referred to hereinafter as V-RAM) because binary data for the display are loaded into the memory and can be called up again therefrom. The binary information of at least one pixel is associated with each memory location, depending on its respective bit depth; the corresponding memory content therefore determines which pixel is switched light or dark at a given time. Control signals are produced in a special functional part of such an LCD processor and delivered to the LCD display at the right time with the image data called up from the memory.

The driver circuits that are available as standard and which are thus incorporated into an autarchical processor structure have the advantage of simplicity of use but the disadvantage that they are very expensive. For, as they are configured for universal use, they ensure very comprehensive functionalities that are utilized only to a small part in specific uses. The user must therefore involve himself with costs for functions which he does not at all wish to use. That is critical in particular in use areas that—as in the field of large-scale domestic appliances—are developed against a low price that is dictated by the market, and therefore must manage with minimal display functions, at any event in the basic version.

### SUMMARY OF THE INVENTION

It is accordingly an object of the invention to provide a driver circuit for an LCD display which overcomes the above-mentioned disadvantages of the prior art devices of this general type. The technical object of the present invention is therefore that of providing a driver circuit for an LCD display, which is optimized for comparatively less complex uses, preferably those as occur in a washing machine or the like large-scale domestic appliance, in order to be able to actuate a display as an operating aid with the minimum possible increase in circuitry expenditure and thus at very advantageous cost.

With the foregoing and other objects in view there is provided, in accordance with the invention, a driver circuit for mosaic-like image representation on an LCD display. The driver circuit contains a V-RAM for loading with image data by way of a host processor and an address counter having column and line counters clock-controlled by the host processor. The column and line counters, after actuation of all image matrix points of a line in the V-RAM, advance by a respective line and after counting through all lines the column and line counters advance to a first of a column addresses at a beginning of a first of the lines of a next image representation. A matrix of the LCD display having memory addresses, irrespective of a size of the V-RAM, but having regard to a number, corresponding to a memory depth of the V-RAM, of pixels to be actuated in mutually juxtaposed relationship on an image line and all the memory addresses which occur in succession here then corresponding to the memory depth being cyclically called up by the address counter.

In that respect, use is made of the fact that the large memory components that can be used as V-RAMs, in contrast to the universal LCD processors, can be obtained very inexpensively. The configuration in accordance with the present invention however now involves foregoing using all memory cells available in such a memory component, that is to say occupying same with image data. Rather, now only those memory cells are used for that purpose, which can be addressed with a binary counting circuit which is of a particularly simple configuration and which is to be run through cyclically. As a result the circuitry expenditure for the optimized LCD driver circuit is reduced to a relatively simple circuit configuration of logic gates which are clock controlled from the host processor, which circuit configuration can therefore be implemented very inexpensively using standard PALs. Without foregoing necessary functionalities, the configuration according to the invention thus reduces the costs to the order of magnitude of a third of the price of conventional, processor-oriented LCD driver circuits and thereby affords the possibility of fitting even large-scale domestic appliances which involve simple equipment, with image displays, for facilitating operation of the appliance, in spite of the low price point dictated by the market.

In accordance with an added feature of the invention, a decoder is connected to the address counter. The address counter is a binary address counter having successive dividers operating as the column and line counters. The successive dividers are limited by way of reset feedbacks from the decoding logic to a respective counting volume of a number of columns per line, divided by a bit depth at the memory addresses in the V-RAM, or to the number of lines for image construction of the LCD display, in order in each case to be reset to zero with attainment of a last column address per line or a last line address per image by way of the decoding logic.

In accordance with a further feature of the invention, buses interconnect the address counter, the decoding logic, and the V-RAM to each other. The successive dividers have binary divider stages with logic counter states of the binary divider stages addressing the V-RAM and in parallel therewith the LCD display by way of the decoding logic and the buses.

In accordance with another feature of the invention, a bidirectional bus data driver with tristate outputs is connected between the V-RAM and the host processor. The image data can be communicated from the host processor to the V-RAM by way of the bidirectional bus data driver.

In accordance with an additional feature of the invention, a data change-over switch is connected to the V-RAM, and for each memory address, eight bit-deep image data are passed from the V-RAM to the LCD display by way of the data change-over switch which during a presence of a memory address breaks the image data set of one byte which has just been read out of the V-RAM into a sequence of two nibble words each of four bits and successively transfers them to the LCD display.

In accordance with another added feature of the invention, each pixel in the matrix of the LCD display, irrespective of the size of the V-RAM, having regard to the memory depth, in accordance with a number of pixels to be actuated in mutually juxtaposed relationship on an image line in relation to an image address, has only the one memory address and all addresses which occur in succession in counting terms are cyclically called up in the sequence by the address counter.

In accordance with a further additional feature according to the invention, a decoder is connected downstream of the address counter. The decoder feeds a synchronizing line to the host processor for switching over the column and line counters.

In accordance with a concomitant feature of the invention, the V-RAM is addressed directly by the column and line counters and a correct association of the image data with matrix pixels of the LCD display is effected by software by the host processor being a synchronized host processor.

Other features which are considered as characteristic for the invention are set forth in the appended claims.

Although the invention is illustrated and described herein as embodied in a driver circuit for an LCD display, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block circuit diagram, abstracted to what is functionally essential, to show the incorporation of an LCD driver circuit into an actuation of a mosaic display according to the invention;

FIG. 2 is a detailed block circuit diagram of the driver circuit as illustrated in FIG. 1, but without having regard to a clock control of logic circuits from the host processor and without having regard to the periodic change in polarity in point-wise LCD brightness control for avoiding electrolytic decomposition phenomena; and

FIG. 3 is a block circuit diagram of a driver circuit that is further simplified in comparison with FIG. 2.

### DESCRIPTION OF THE PREFERRED EMBODIMENTS

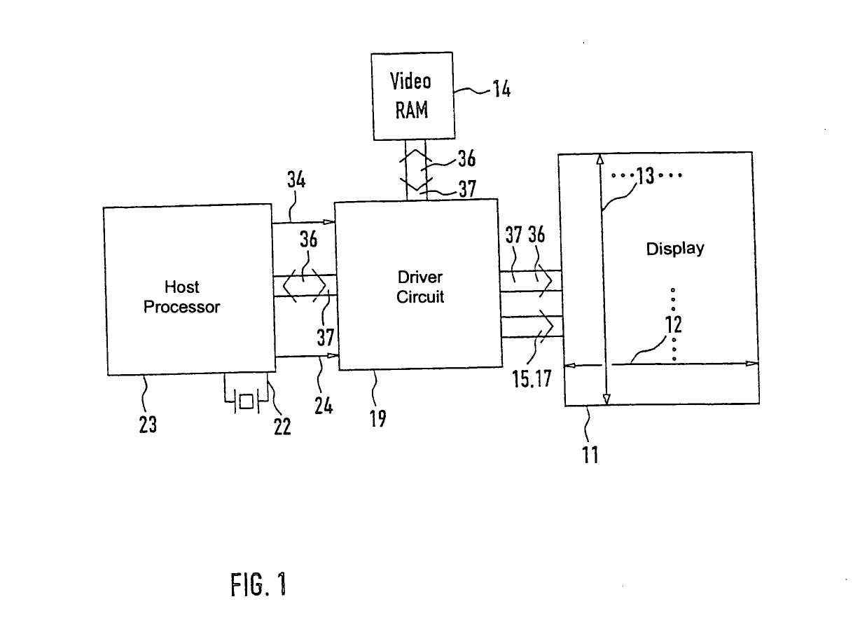

Referring now to the figures of the drawing in detail and first, particularly, to FIG. 1 thereof, there is shown a mosaic image on an LCD display 11. The mosaic display is built up as follows, starting from the zero position: a first zero line 12 (this is the uppermost or the lowermost line 12 in the display 11) is actuated. Each of the lines 12 contains typically 320 mutually juxtaposed pixels, corresponding to 320 columns 13 in the image of the display 11. The items of information, that are to be displayed visually, of the respective pixel (also referred to hereinafter as image data 36) are predetermined by current binary values (“light” or “dark”) of the respectively associated cell in the image memory, V-RAM 14. As it is only the information of one bit (“light” or “dark”) that is required for each pixel, that is to say for each intersection of lines 12 and columns 13 in the display 11, but each memory cell is a plurality of bits deep, many pixels which are disposed in mutually juxtaposed relationship in the display 11 on a line 12 are correspondingly actuated at each memory cell address. Insofar therefore as for example at each of the successive column addresses 15 usually a piece of 4-bit information is read out in parallel, a line 12 is already filled with 320/4=80 successive column addresses 15, and it is then possible to advance to the first of the 80 column addresses in the next adjacent one of the lines 12.

For this embodiment accordingly, line-wise advance with a simultaneous return to the first pixel at the first column address 15 in the next following line 12 is implemented with counting to the 80th column address 15, that is to say attainment of the binary counting position 80 as the column address 15. Besides serving to reset, a column address counter 20.1 also serves as a line switching-over signal 16.

After counting through a further 80 column addresses 15, the next line 12 is also occupied with pixel data and the switching-over signal 16 which now appears switches to the number of the next following line address 17, that is to say to the next adjacent line 12; and so forth, until the last (the 239th) of the lines 12 is also filled.

With the end of that last line 12 of the image in the display 11, an image pulse 18 for constructing the next following image switches the address counter 20 back to the first column address 15 in the first line 12 of the next image to be presented by the display 11—if the content of the V-RAM 14 was not altered in the meantime, that is again the same image.

It is possible in that way to operate for example the LCD display 11 of type 32F62 from Technologics Corporation with 240 lines 12 and 320 columns 13 (that is to say with 320×240=76,800 pixels per image).

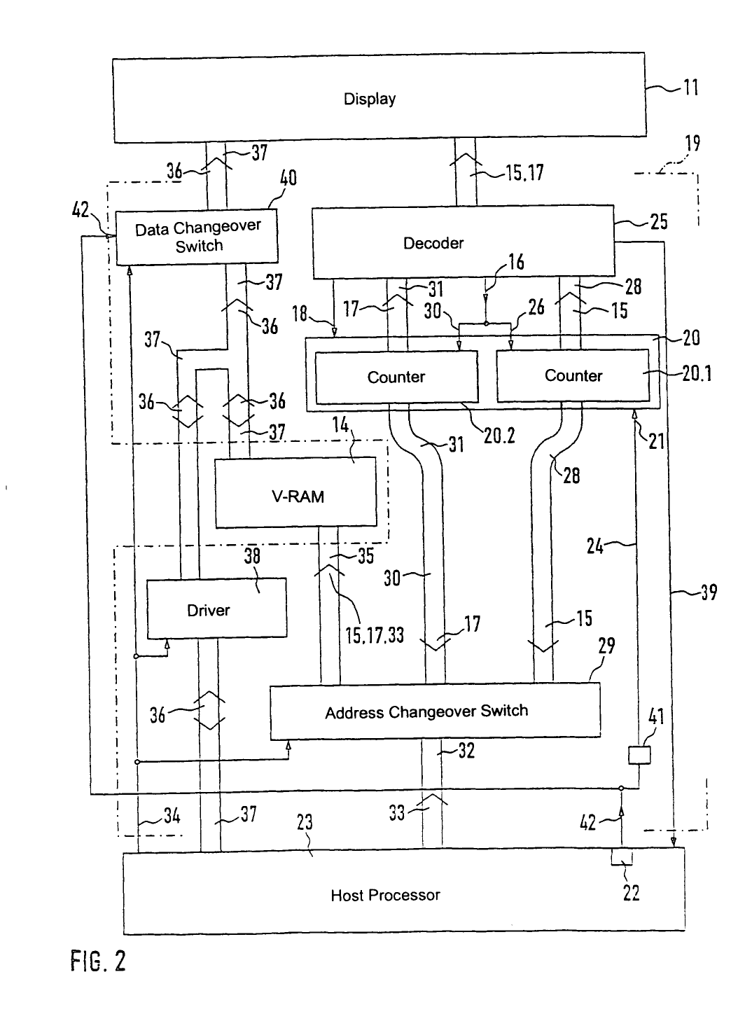

In that sense the purpose of an LCD driver circuit 19 with its address counter 20 is to cyclically read out image data 36 stored in the V-RAM 14 by a host processor 23 and feed same to the LCD display 11 in correct pixel relationship in respect of column and line addresses 15, 17 (see FIG. 2). In order to implement that at the lowest possible circuitry expenditure, the present invention provides that the respective binary values of the individual pixels (that is to say of the image data 36) are only still stored in the V-RAM 14 at such memory addresses 15, 17 which can be addressed in the simplest counting sequence and therefore easily in a cyclic mode. For that purpose in a binary-coded counter 20 two counting circuits—a column counter 20.1 for the pixels of a line 12 and a line counter 20.2 connected downstream thereof for the lines 12 in the image of the display 11—each continuously circulate, actuated by way of a clock line 24 by counting pulses 21 which are derived from a clock circuit 22 of the host processor 23 so that the driver circuit 19 does not have to be equipped with its own oscillator for that purpose. By virtue of the binary coding the counter 20 can be easily embodied in the form of a series circuit by bistable trigger stages (flip-flops), whereby, as a consequence of binary division of the repetition rate of the counting pulses 21, for example with eight such trigger stages, it could count up to 2⁸=256.

The counter condition of the cascade of the column counter 20.1 in the counter 20 is continuously monitored by a decoding logic 25 and, with the detection of all pixels (that is to say columns 13) of a line 12, the column counter 20.1 is reset to zero by the switching-over signal 16 by way of a reset line 26. In that way the flip-flops of the column counter 20.1, by way of a column bus 28 with six lines with the column numbers in succession in a binary counting sequence deliver the lower addresses 15 both to the display 11 and also—in the embodiment shown in FIG. 1 by way of an address change-over switch 29 controlled by the host processor 23—to the V-RAM 14.

The column counter 20.1 is followed in the address counter 20 by the further cascade of binary divider stages as the line counter 20.2 which is connected downstream of the column counter 20.1. It contains for example a series circuit of eight flip-flops and supplies in a binary counting sequence successive line numbers as the line addresses 17. For that purpose the counting position of the line counter 20.2 is increased by the value of one by way of a clock line 30 with each switching-over signal 16 at the end of the counting capacity of the column counter 20.1, therefore as soon as a line 12 is filled with pixel data 36. In the present example the line counter 20.2 thus counts from line 0 to the line 239 and is then reset to zero again by way of the decoding logic 25 by the image pulse 18 with the entire address counter 20. In that way the line counter 20.2, with the sequence of line numbers, by way of a line bus 31 with eight lines delivers the upper addresses 17 to the display 11 and to the V-RAM 14.

Therefore each storage location, belonging to a sequence of four pixels of the LCD display 11, of four bit depth in the V-RAM 14, can be specifically addressed with the address numbers 15 from the column counter 20.1 and the address numbers 17 from the line counter 20.2.

In addition, by way of a bus 32, the address change-over switch 29 also receives addresses 33 of a fourteen bit width from the host processor 23. The address change-over switch 29, influenced by the host processor 23 by control line 34, can switch those three groups of addresses 15, 17, 33 by way of a bus 35 selectively to the V-RAM 14.

Therefore, besides the column and line counters 20.1, 20.2, the memory addresses of the V-RAM 14 can also be selectively addressed from the host processor 23. The latter is effected from the host processor 23 by way of the bus 32 and the address change-over switch 29, as well as the bus 35 when the V-RAM 14 is to be written with image data 36 from the host processor 23 or if image data 36 are to be read thereinto.

They pass by way of an image bus 37 with data driver 38. This is a bidirectional bus driver with tristate outputs. It can therefore drive data 36 in both directions; however it can also be entirely removed in order not to interfere with a transfer of the image data 36 from the V-RAM 14 by way of a further branch of the image bus 37 to the display 11.

Enablement of the image data traffic 36 between the host processor 23 and the V-RAM 14 or between the V-RAM 14 and the display 11 is regulated in respect of time. For example the host processor 23 has access to the V-RAM 14 whenever the last (least significant) bit of the column number 15 is just zero (low). In contrast, if it is +U (high), the control logic in the LCD display 11 has access to the V-RAM 14 by way of the image bus 37. FIG. 2 takes account of the fact that for that purpose it is desirable to synchronize the host processor 23 by way of line 39 from the decoding logic 25.

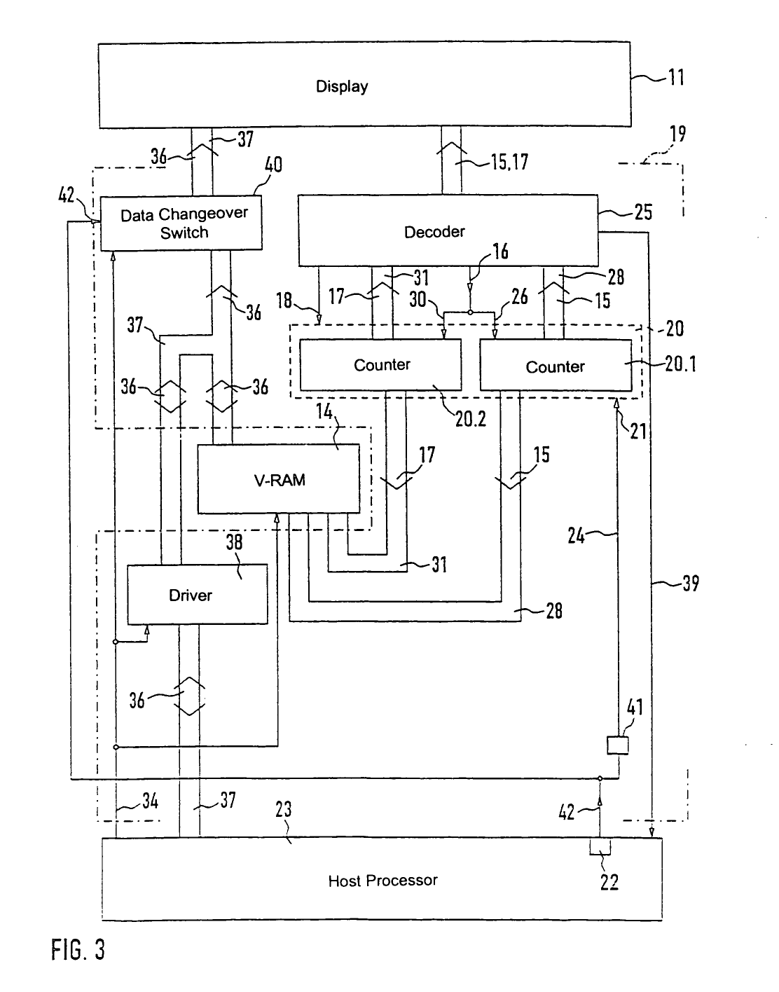

As described hereinbefore with reference to FIG. 2, the functionality, which is afforded in any case, of the host processor 23 is used for the overall control function for mosaic-like point-wise image construction, so that the driver circuit 19 can be configured as simply as possible from the functional point of view. In accordance with a development of the invention the driver circuit 19 can even be further simplified by way of intelligent software. A possible configuration in that respect is shown in FIG. 3. It is based on the fact that the address buses 28, 31 from the column counter 20.1 and the line counter 20.2 always actuate the V-RAM 14 with the addresses 15, 17 in the same sequence. The addressing thereof therefore no longer has to be implemented specifically by way of the host processor 23, the address buses 28, 31 from the column and line counters 20.1, 20.2 can lead directly to the V-RAM 14. That eliminates the expenditure on typically four components for an address change-over switch (29 in FIG. 2). The host processor 23 only has to send the image data 36 to the V-RAM 14 by way of the data driver 38 at the correct time. For that purpose, synchronization of the host processor 23 by the address decoding logic 25 by way of the line 39 is particularly appropriate.

In FIGS. 2 and 3 of the drawing, a data change-over switch 40 with a tristate characteristic is also provided for delivery of the image data 36 read out of the V-RAM 14 to the control electronics, in the display 11. That however is only required if the V-RAM 14, in accordance with modern memory technology, is read out for each memory address 15/17 with eight bit depth (that is to say a byte instead of with four bit depth as described hereinbefore), while actuation of an LCD display 11 is usually still effected for each column address 15 in parallel for four pixels, that is to say with the nibble words of only four bit depth per memory address 15/17. The change-over switch 40 is provided for dividing up the eight bit-deep column address 15 into two groups each of four pixels, the groups occurring in succession on the line 12. In order to implement the switching-over of the switch before the arrangement further counts to the next column number 15, switching-over pulses 42 of double the frequency of the counting pulses 21 are originally derived from the clock circuit 22 of the host processor 23. That doubled counting frequency is halved to the counting clock of the pulses 21 in a binary step-down device 41 connected on the input side of the column counter 20.1. The step-down device 41 can therefore be embodied as a first divider stage of the counter 20 upstream of its cascade of the column counter 20.1. In any event, in each case prior to switching-over thereof to the next column address 15 on the bus 28, a switching-over pulse 42 appears at the data change-over switch 40, and the pulse 42, after the first four bits, also reads out the second four bits for the eight pixels, to be actuated at a column address 15, in the current line 12, from the V-RAM 14. In this configuration to fill a line 12 therefore the column counter 20.1 only needs to count up to 320/8=40. The switching-over pulse 42 which occurs with the appearance of the next counting pulse 21 then switches the data change-over switch 40 to the first four bits of the next eight bit-deep column address 15.

Irrespective of the memory depth of the V-RAM 14 used it is therefore to be noted that, in spite of the enormous market-originating price pressure, even large-scale domestic appliances involving more basic and simpler equipment can be fitted with LCD displays 11 for example for user guidance, and the expensive universal driver circuits (LCD controller ICs) with their many unused functionalities are replaced in accordance with the invention by simple logic gate circuits synchronized by the host processor 23 for the communication of image data 36 between the V-RAM 14 and the display 11, for cyclically successively counting through the pixels (that is to say columns 13) per image line 12 and the lines 12 per image representation of the display 11. As now not only a matrix position in the image of the display 11 but also an address in the V-RAM 14 corresponds to each counting position 15/17 per image, the memory 14 is not utilized as it is not occupied with image data 22 continuously but only in a suitable section; which however is not a problem because large image data memories 14 are available very inexpensively in comparison with an expensive LCD controller IC.

1. A driver circuit for mosaic-like image representation on an LCD display, the driver circuit comprising:
a V-RAM for loading with image data by way of a host processor; and
an address counter having column and line counters clock-controlled by the host processor, said column and line counters after actuation of all image matrix points of a line in said V-RAM advance by a respective line and after counting through all lines said column and line counters advance to a first of a column addresses at a beginning of a first of the lines of a next image representation;
a matrix of the LCD display having memory addresses, irrespective of a size of said V-RAM, but having regard to a number, corresponding to a memory depth of said V-RAM, of pixels to be actuated in mutually juxtaposed relationship on an image line and all the memory addresses which occur in succession here then corresponding to said memory depth being cyclically called up by said address counter.

2. The driver circuit according to claim 1,
further comprising a decoding logic connected to said address counter; and
wherein said address counter is a binary address counter having successive dividers operating as said column and line counters, said successive dividers being limited by way of reset feedbacks from said decoding logic to a respective counting volume of a number of columns per line, divided by a bit depth at the memory addresses in said V-RAM, or to the number of lines for image construction of the LCD display, in order in each case to be reset to zero with attainment of a last column address per line or a last line address per image by way of said decoding logic.

3. The driver circuit according to claim 2,
further comprising buses interconnecting said address counter, said decoding logic, and said V-RAM to each other; and
wherein said successive dividers have binary divider stages with logic counter states of said binary divider stages addressing said V-RAM and in parallel therewith the LCD display by way of said decoding logic and said buses.

4. The driver circuit according to claim 1, further comprising a bidirectional bus data driver with tristate outputs connected between said V-RAM and the host processor, the image data can be communicated from the host processor to said V-RAM by way of said bidirectional bus data driver.

5. The driver circuit according to claim 1, further comprising a data change-over switch connected to said V-RAM, and for each memory address, eight bit-deep image data are passed from said V-RAM to the LCD display by way of said data change-over switch which during a presence of a memory address breaks the image data set of one byte which has just been read out of said V-RAM into a sequence of two nibble words each of four bits and successively transfers them to the LCD display.

6. The driver circuit according to claim 1, wherein each pixel in the matrix of the LCD display, irrespective of said size of said V-RAM, having regard to said memory depth, in accordance with a number of pixels to be actuated in mutually juxtaposed relationship on an image line in relation to an image address has only the one memory address and all addresses which occur in succession in counting terms are cyclically called up in the sequence by said address counter.

7. The driver circuit according to claim 1, further comprising a decoding logic connected downstream of said address counter, said decoding logic feeding a synchronizing line to the host processor for switching over said column and line counters.

8. The driver circuit according to claim 1, wherein said V-RAM is addressed directly by said column and line counters and a correct association of the image data with matrix pixels of the LCD display is effected by software by the host processor being a synchronized host processor.
